(19) United States
(12) Patent Application Publication
(10) Pub. No.: US 2022/0222101 A1
(43) Pub. Date: Jul. 14, 2022

(54) INFORMATION PROCESSING DEVICE, INFORMATION PROCESSING SYSTEM, AND BAND CONTROL METHOD

(71) Applicant: FUJITSU LIMITED, Kawasaki-shi (JP)

(72) Inventor: OSAMU SHIRAKI, Kawasaki (JP)

(73) Assignee: FUJITSU LIMITED, Kawasaki-shi (JP)

(21) Appl. No.: 17/476,511

(22) Filed: Sep. 16, 2021

(30) Foreign Application Priority Data
Jan. 8, 2021 (JP) 2021-002413

(51) Int. Cl. G06F 9/455; G06F 9/50

(52) U.S. Cl. CPC G06F 9/45558; G06F 2009/4557; G06F 9/5083

(57) ABSTRACT

An information processing device including: a memory; and a processor coupled to the memory and configured to: acquire use band information for each of a plurality of tenants each including a plurality of workloads in another information processing device; calculate a band to be distributed to the workload to be processed by the information processing device on the basis of the use band information; and set the band which is calculated.

### CROSS-REFERENCE TO RELATED APPLICATION

This application is based upon and claims the benefit of priority of the prior Japanese Patent Application No. 2021-2413, filed on Jan. 8, 2021, the entire contents of which are incorporated herein by reference.

### FIELD

The embodiment discussed herein is related to an information processing device, an information processing system, and a band control method.

### BACKGROUND

In recent years, a plurality of applications for each of a plurality of tenants have been executed sharing an information processing system including a plurality of nodes. Here, the node is an information processing device that performs information processing. In such an information processing system, a plurality of workloads is executed on each node. Here, the workload is an execution image of an application including middleware and the like.

Japanese Laid-open Patent Publication No. 2017-41858, Japanese Laid-open Patent Publication No. 2014-116775, and Japanese Laid-open Patent Publication No. 2001-237831 are disclosed as related art.

### SUMMARY

According to an aspect of the embodiments, an information processing device including: a memory; and a processor coupled to the memory and configured to: acquire use band information for each of a plurality of tenants each including a plurality of workloads in another information processing device;

calculate a band to be distributed to the workload to be processed by the information processing device on the basis of the use band information; and set the band which is calculated.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating band control by an information processing system according to a first embodiment;

FIG. 2 is a diagram illustrating a hardware configuration of a node;

FIG. 3 is a diagram illustrating a functional configuration of an agent according to the first embodiment;

FIG. 4 is a diagram illustrating an example of a usage status table;

FIG. 5 is a diagram illustrating an example of a local table;

FIG. 6 is a diagram illustrating an example of a global table;

FIG. 7 is a diagram illustrating an example of a band setting table;

FIG. 8 is a diagram illustrating an example of a setting information table;

FIG. 9 is a flowchart illustrating a flow of port information acquisition processing;

FIG. 10A is a flowchart (1) illustrating a flow of information exchange processing;

FIG. 10B is a flowchart (2) illustrating a flow of the information exchange processing;

FIG. 11 is a flowchart illustrating a flow of band calculation processing;

FIG. 12 is a flowchart illustrating a flow of allocation band calculation processing;

FIG. 13 is a flowchart illustrating a flow of band initial setting processing;

FIG. 14 is a flowchart illustrating a flow of port information setting processing;

FIG. 15 is a diagram illustrating an example of band calculation;

FIG. 16 is a diagram for describing band control by an information processing system according to a second embodiment;

FIG. 17 is a diagram illustrating a functional configuration of an agent according to the second embodiment;

FIG. 18A is a flowchart (1) illustrating a flow of band control determination processing;

FIG. 18B is a flowchart (2) illustrating a flow of band control determination processing;

FIG. 19 is a diagram illustrating an example of a configuration of an information processing system according to a third embodiment;

FIG. 20 is a diagram illustrating an example of a configuration of an information processing system according to a fourth embodiment; and

FIG. 21 is a diagram for describing that allocation of communication resources is not fair among tenants.

### DESCRIPTION OF EMBODIMENTS

In particular, in a case of executing an application by a container, more workloads (on the order of 100) are executed on one node as compared with a case of executing an application on a virtual machine (VM). Here, the container is similar to the VM in that the container is an application execution environment isolated from other users but is different from the VM in that the container does not have an operating system (OS). That is, a plurality of containers is executed on one OS.

Note that, as an existing technique related to band control, there is a band control system that performs band control to implement a band secure service and a band distribution service in a virtual environment. This band control system preferentially allocates a certain band to a virtual machine that uses the band secure service that secures the certain band from a band available on a host server. Then, the band control system adjusts the band to be allocated to the virtual machine that uses the band distribution service for distributing a band obtained by excluding the band actually used by the band secure service from the available band according to a load situation by communication of the host server.

Furthermore, as an existing technique related to band control, there is a network system including a plurality of communication devices accommodating a plurality of sessions and a band control server connected to each of the plurality of communication devices and improving a band utilization rate. In this network system, the band control server includes a memory and a network interface, and stores communication quality information including information for calculating a minimum band to be allocated to each of a plurality of sessions in the memory. Then, the band control server receives session information regarding the session to be accommodated from each of the plurality of communication devices via the network interface, and allocates the minimum band to each of the plurality of sessions on the basis of the received session information and the communication quality information. Then, the band control server notifies each of the plurality of communication devices of each of the allocated minimum bands.

Furthermore, as an existing technique, there is a network management system that can monitor an operation status of a policy at each node according to a set Quality of Service (QoS) policy and guarantee the operation itself of the policy. In this network management system, a policy server assigns a unique policy identification (ID) to each of the QoS policies for a plurality of nodes in the network set via an administrator terminal, and centrally manages the QoS policies as policy information. Then, the policy server sets the QoS policy for each node together with a policy server KEY assigned to the policy server by referring to node information. Each node identifies a flow specified by the QoS policy set in a QoS parameter management table, and collects band monitoring information in a QoS report management table for each policy ID.

Then, each node transmits the band monitoring data including the policy ID and the policy server KEY to the policy server at certain time intervals T1. In the policy server, a band report processing unit performs band analysis and alarm analysis for band monitoring data from each node at certain time intervals T2.

In a case where a plurality of applications is executed sharing an information processing system including a plurality of nodes for each of a plurality of tenants, there is a problem that allocation of communication resources is not fair among the tenants in the entire information processing system.

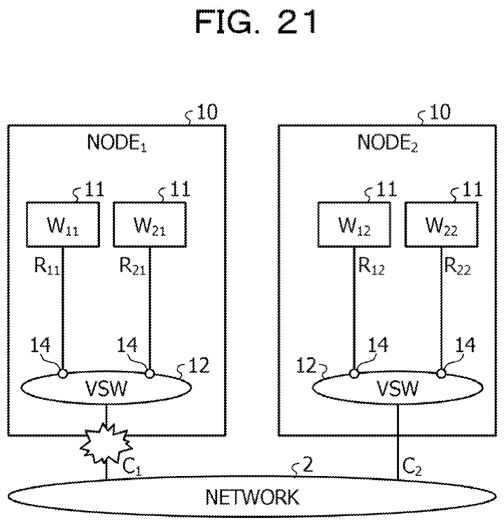

FIG. 21 is a diagram for describing that allocation of communication resources is not fair among tenants. In FIG. 21, the information processing system has a node₁ and a node₂. Furthermore, Wₜᵢ is a workload on a node i of a tenant t, Rₜᵢ is a rate of traffic generated by Wₜᵢ, and Cⱼ is a bandwidth of a switch port j.

Furthermore, Rₜ is a total sum of Rₜᵢ with respect to i (Rₜ=ΣᵢRₜᵢ), and Lₜ (not illustrated) is a proportion of a band given to the tenant t. Furthermore, the state of R₁:R₂=L₁:L₂ is defined as “fair”. Then, when the band is insufficient, for example, when R₁₁+R₂₁>C₁, the band is limited to R₁: R₂=L₁:L₂. Furthermore, at this time, C₂>R₁₂+R₂₂, and the band is not limited on the C₂ side.

In the case of controlling the band only with information in the local node, the controlled bands r₁₁ and r₂₁ are as follows.

r₁₁=L₁C₁/(L₁+L₂)

r₂₁=L₂C₁/(L₁+L₂)

However, this band control does not reflect the states (R₁₂, R₂₂) of a remote node (node₂), and the band allocation between tenants may be unfair as the information processing system as a whole. For example, in the case where R₁₂ is very large compared to other traffic, then R₁: R₂=(R₁₁+R₁₂):(R₂₁+R₂₂) is satisfied, which makes the band allocation between tenants unfair.

In one aspect, an object of the present embodiment is to control a band so as to be fair among tenants as an information processing system as a whole.

Hereinafter, embodiments of an information processing device, an information processing system, and a band control method disclosed in the present application will be described in detail with reference to the drawings. Note that the embodiments do not limit the disclosed technique.

### First Embodiment

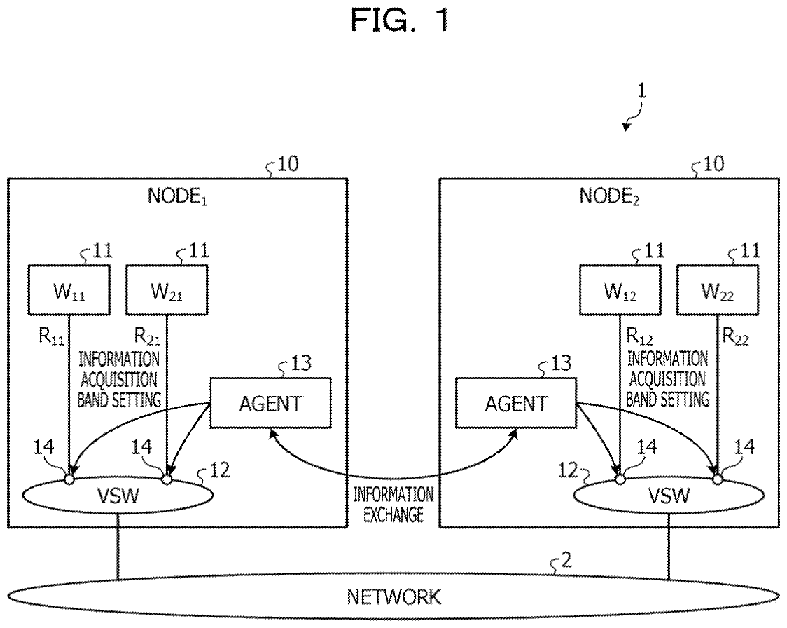

First, band control of an information processing system according to a first embodiment will be described. FIG. 1 is a diagram illustrating band control by the information processing system according to the first embodiment. As illustrated in FIG. 1, an information processing system 1 according to the first embodiment has two nodes 10 represented by a node₁ and a node₂. The two nodes 10 are connected by a network 2. Note that only two nodes 10 are illustrated here for convenience of description, but the information processing system 1 may have three or more nodes 10.

The node 10 is an information processing device that performs information processing. A workload 11 is executed on the node 10. In FIG. 1, the workload 11 is represented as W₁₁. Wₜᵢ is the workload 11 on a node i of a tenant t, and Rₜᵢ is a rate of traffic generated by Wₜᵢ. Note that workload 11 refers to, for example, a container in a container environment.

A virtual switch 12 and an agent 13 operate on the node 10. In FIG. 1, the virtual switch 12 is represented as VSW 12. The workload 11 communicates through a virtual port 14 of the virtual switch 12.

The agent 13 monitors statistical information of the virtual switch 12 and acquires a use band in the virtual port 14 of each workload 11. Furthermore, the agent 13 exchanges information with the agent 13 operating on another node 10 via the network 2, and acquires, for each tenant, information indicating a communication state on the another node 10. Then, the agent 13 calculates the band to be distributed to the virtual port 14 of the node 10 so as to be fair among tenants in the entire information processing system 1 on the basis of the use band in the virtual port 14 of each workload 11 and the information acquired from the another node 10. Then, the agent 13 sets the calculated band to the virtual port 14 of the node 10.

In this way, the agent 13 exchanges information with the agent 13 operating on another node 10, and calculates the band to be distributed to the virtual port 14 of the node 10 so as to be fair among tenants in the entire information processing system 1 on the basis of the information exchanged with the another node 10. Therefore, the information processing system 1 can control the band so as to be fair among the tenants as a whole.

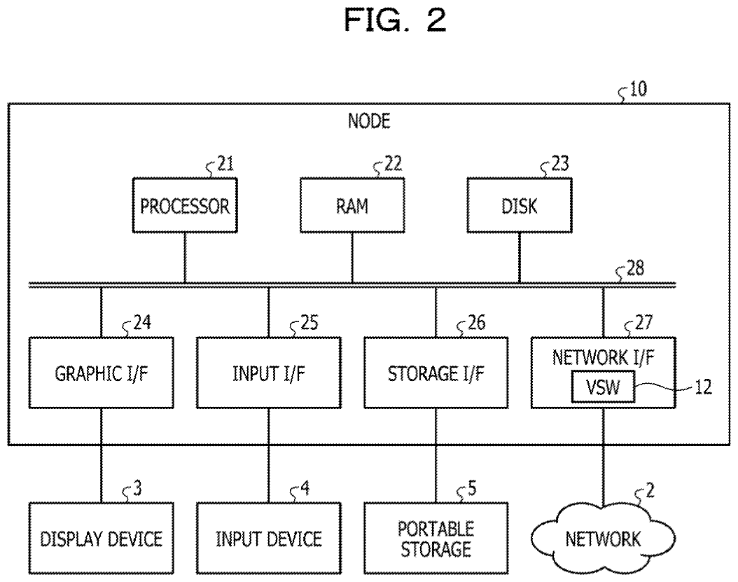

Next, a hardware configuration of the node 10 will be described. FIG. 2 is a diagram illustrating a hardware configuration of the node. As illustrated in FIG. 2, the node 10 includes a processor 21, a random access memory (RAM) 22, a disk 23, a graphic interface (I/F) 24, an input I/F 25, and a storage I/F 26, and a network I/F 27. The processor 21, the RAM 22, the disk 23, the graphic I/F 24, the input I/F 25, the storage I/F 26 and the network I/F 27 are connected to a bus 28.

The processor 21 is a processing device that reads a program from the RAM 22 and executes the program. The RAM 22 is a memory that stores the program, a halfway result of execution of the program, and the like. The disk 23 is a non-volatile storage device that stores programs and data. The graphic I/F 24 is an interface used for connection with a display device 3. The input I/F 25 is an interface used for connection with an input device 4 such as a mouse and a keyboard. The storage I/F 26 is an interface used for connection with a portable storage 5. The network I/F 27 is an interface used for connection with the network 2. The network I/F 27 has a function of the virtual switch 12.

The agent 13 is stored in a digital versatile disc (DVD), which is an example of a recording medium that can be read by the node 10, read from the DVD, and installed in the node 10. Alternatively, the agent 13 is stored in a database of another information processing system connected via the network I/F 27, read from the database or the like, and installed on the node 10. Then, the installed agent 13 is stored in the disk 23, read into the RAM 22, and executed by the processor 21.

Next, the functional configuration of the agent 13 will be described.

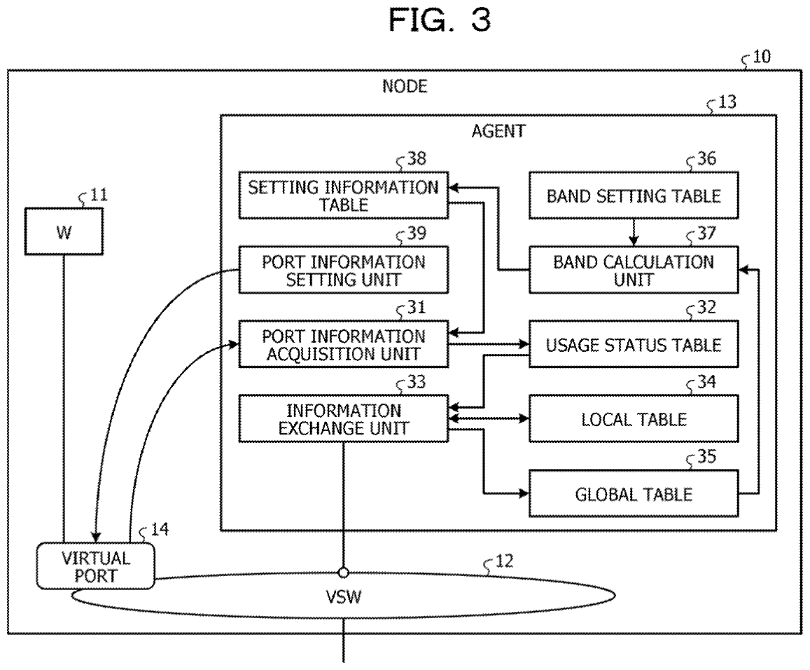

FIG. 3 is a diagram illustrating a functional configuration of an agent according to the first embodiment. As illustrated in FIG. 3, the agent 13 has a port information acquisition unit 31, a usage status table 32, an information exchange unit 33, a local table 34, and a global table 35. Furthermore, the agent 13 has a band setting table 36, a band calculation unit 37, a setting information table 38, and a port information setting unit 39. Note that the information exchange unit 33 is an example of an acquisition unit. Furthermore, the band calculation unit 37 is an example of a calculation unit. Furthermore, the port information setting unit 39 is an example of a setting unit.

The port information acquisition unit 31 acquires a band use status of each virtual port 14 and stores the band use status in the usage status table 32. For example, the port information acquisition unit 31 monitors port statistical information of the virtual switch 12 and acquires the band use status of each virtual port 14.

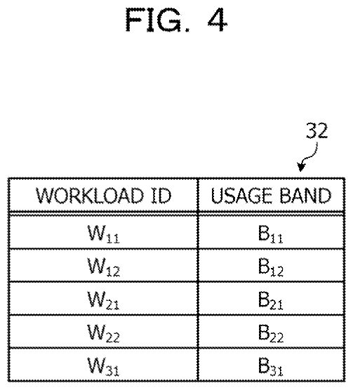

The usage status table 32 is a table that stores the band usage status of each workload. FIG. 4 is a diagram illustrating an example of the usage status table. As illustrated in FIG. 4, the usage status table 32 stores a workload ID and a usage band in association with each other. The workload ID is an identifier that identifies the workload 11. The usage band is the band used by the workload 11 on the virtual port 14. For example, a workload W₁₁ uses a band B₁₁. Note that the virtual port 14 and the workload 11 are associated with each other on the basis of the information in the setting information table 38.

Returning to FIG. 3, the information exchange unit 33 creates the local table 34 on the basis of the information stored in the usage status table 32. Furthermore, the information exchange unit 33 exchanges content of the local table 34 with the agent 13 of another node 10 and creates the global table 35 on the basis of the band use status of the another node 10 and the information stored in the local table 34.

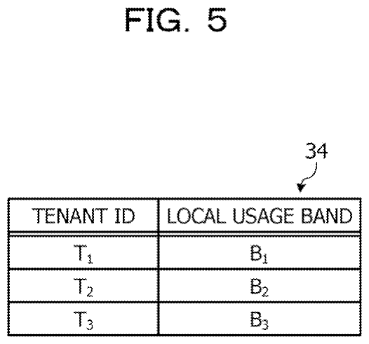

The local table 34 stores the band usage status on the node 10 for each tenant. FIG. 5 is a diagram illustrating an example of the local table. As illustrated in FIG. 5, the local table 34 stores a tenant ID and the local usage band in association with each other. The tenant ID is an identifier that identifies a tenant. The local usage band is the band used by the tenant on the node 10. For example, B₁=B₁₁+B₁₂, B₂=B₂₁+B₂₂, and B₃=B₃₁ are calculated on the basis of the usage status table 32 illustrated in FIG. 4.

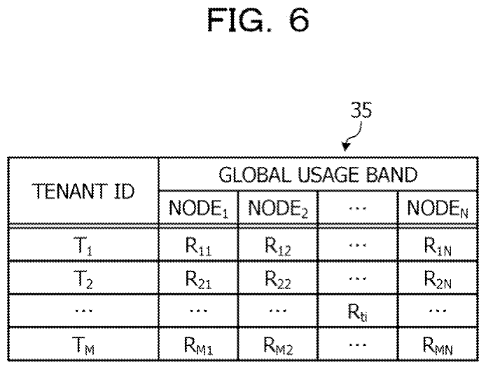

Returning to FIG. 3, the global table 35 stores, for each tenant, the band usage status on each node 10 included in the information processing system 1. FIG. 6 is a diagram illustrating an example of a global table. As illustrated in FIG. 6, the global table 35 stores the tenant ID and the global usage band in association with each other. The tenant ID is an identifier that identifies a tenant. The global usage band is the band used by the tenant in the information processing system 1. In the global usage band, the information received from the another node 10 by the information exchange unit 33 and the information copied from the local table 34 about the node 10 are stored for the each node 10. For example, a tenant T₁ uses a band R₁₁ at the node₁, uses a band R₁₂ at the node₂, . . . , and uses a band R_{1N} at a node_{N}.

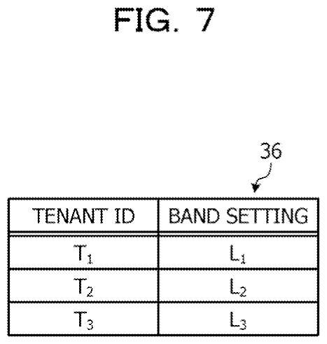

Returning to FIG. 3, the band setting table 36 stores the proportion (weight) of the band for each tenant. FIG. 7 is a diagram illustrating an example of a band setting table. As illustrated in FIG. 7, the band setting table 36 stores the tenant ID and band setting in association with each other. The tenant ID is an identifier that identifies a tenant. The band setting is the proportion of the band allocated to a tenant. For example, in the case where the band at the proportions of L₁, L₂, and L₃ is allocated to three tenants identified with the tenant T₁, the tenant T₂, and a tenant T₃, the band usage of the three tenants identified with the tenant T, the tenant T₂, and the tenant T₃ is expected to be controlled to L₁:L₂:L₃.

Returning to FIG. 3, the band calculation unit 37 calculates an allocation band to each virtual port 14 of the node 10 and stores the allocation band in the setting information table 38. The band calculation unit 37 calculates the allocation band to each virtual port 14 such that the band to be allocated to the tenants in the entire information processing system 1 becomes the proportion stored by the band setting table 36. Note that an example of the calculation method will be described below.

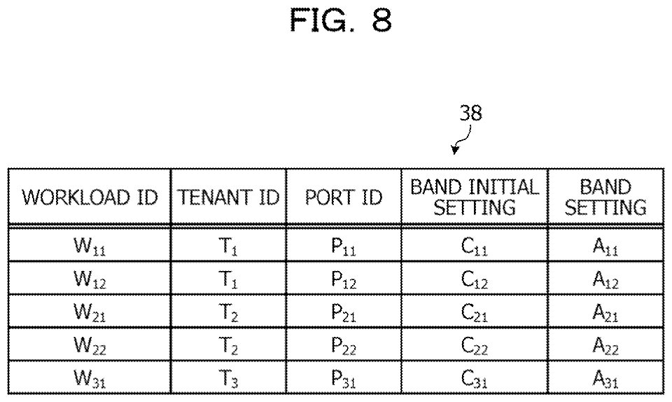

The setting information table 38 stores information of the workload 11. FIG. 8 is a diagram illustrating an example of a setting information table. As illustrated in FIG. 8, the setting information table 38 stores the workload ID, the tenant ID, a port ID, band initial setting, and the band setting in association with one another.

The workload ID is an identifier that identifies the workload 11. The tenant ID is an identifier that identifies a tenant. The port ID is an identifier that identifies the virtual port 14. The band initial setting is a proportion of the band allocated to the workload 11, and is a value before band adjustment. For example, assume that C₁₁ is the band initial setting of the workload 11 that uses P₁₁ as the port ID of the tenant T₁, and C₁₂ is the band initial setting of the workload 11 that uses P₁₂ as the port ID of the tenant T₁. It is assumed that the proportion of the band allocation of the tenant T₁ with respect to other tenants T₂ and T₃ is L₁. Then, the band is allocated such as C₁₁=C₁₂=L₁/2 so as to satisfy C₁₁+C₁₂=L₁. The band setting is a proportion of the band allocated to the workload 11, and is a value after band adjustment. Note that, in the case of the band setting=0, the band setting for the virtual port 14 is not performed. For example, as for the workload W₁₁, the tenant is T₁, the virtual port 14 used is P₁₁, the proportion of the band before band adjustment is C₁₁, and the proportion of the band after band adjustment is A₁₁.

Returning to FIG. 3, the port information setting unit 39 sets the band for the virtual port 14 that limits the band. In the case of the band setting=0, the port information setting unit 39 does not set the band for the virtual port 14.

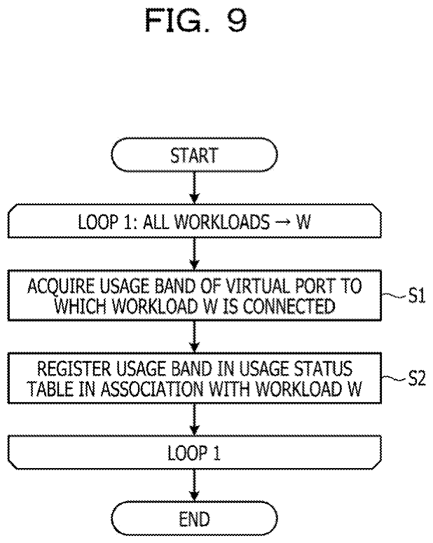

Next, a flow of processing by the agent 13 will be described with reference to FIGS. 9 to 14. FIG. 9 is a flowchart illustrating a flow of port information acquisition processing. Note that the port information acquisition processing is executed at predetermined time intervals. As illustrated in FIG. 9, the port information acquisition unit 31 executes following steps S1 and S2 for all the workloads W, where the workload 11 is W. That is, the port information acquisition unit 31 acquires the statistical information (usage band) of the virtual port 14 to which the workload W is connected from the virtual switch 12 (step

Si) and registers the acquired usage band in association with the workload W in the usage status table 32 (step S2).

In this way, the port information acquisition unit 31 acquires the usage band by the virtual port 14 to which the workload W is connected and registers the usage band in the usage status table 32. Therefore, the agent 13 can identify the band use status of each workload W.

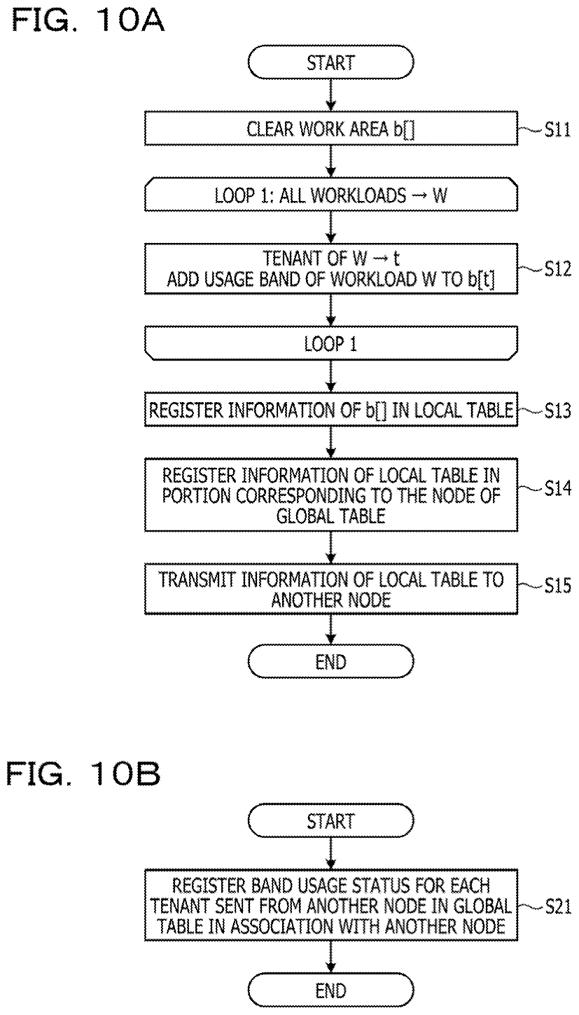

FIG. 10 is flowcharts illustrating flows of the information exchange processing. FIG. 10A illustrates a case of transmitting information of the node 10, and FIG. 10B illustrates a case of receiving information from another node 10. Note that the information exchange processing is executed at predetermined time intervals.

As illustrated in FIG. 10A, the information exchange unit 33 clears a work area b[] (step S11). Then, the information exchange unit 33 adds the usage band of the workload W to b[t] where the workload 11 is W and the tenant of the workload W is t for all the workloads W (step S12). For example, the Information exchange unit 33 refers to the usage status table 32 and adds the usage band of the workload W used by each tenant t for each tenant t.

Then, the information exchange unit 33 registers information of b[] in the local table 34 (step S13) and registers the information of the local table 34 in a portion corresponding to the node of the global table 35 (step S14). Then, the information exchange unit 33 transmits the information of the local table 34 to another node 10 (step S15).

In this way, when the information exchange unit 33 transmits the information of the local table 34 to another node 10, the another node 10 can acquire the band usage status of the node 10 other than the another node 10.

Furthermore, as illustrated in FIG. 10B, the information exchange unit 33 registers the band usage status for each tenant sent from another node in the global table 35 in association with the another node 10 (step S21).

In this way, since the information exchange unit 33 registers the band usage status for each tenant sent from another node in the global table 35 in association with the another node 10, the agent 13 becomes able to perform fair band allocation in the entire information processing system 1.

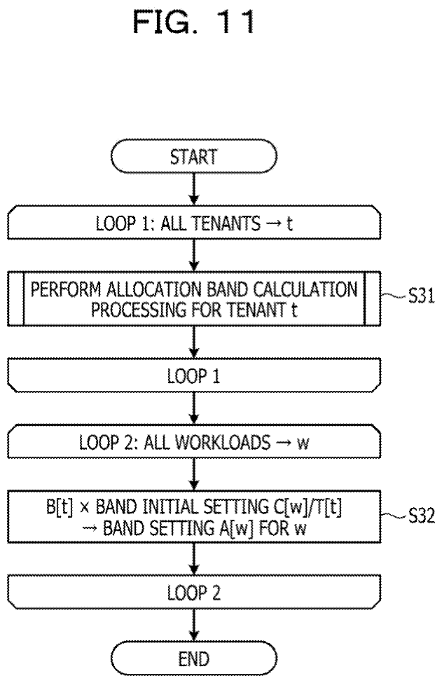

FIG. 11 is a flowchart illustrating a flow of band calculation processing. Note that the band calculation processing is executed at predetermined time intervals.

As illustrated in FIG. 11, the band calculation unit 37 executes following step S31 for all the tenants where t is the tenant. That is, the band calculation unit 37 executes the allocation band calculation processing of the tenant t on the current node 10 (step S31). Here, it is assumed that the allocation band of the tenant t on the current node 10 is calculated as B[t] as a result of the allocation band calculation processing of the tenant t. Note that the flowchart illustrating the flow of the allocation band calculation processing of the tenant t will be described below.

Then, the band calculation unit 37 executes following step S32 for all the workloads, where the workload is w. That is, the band calculation unit 37 calculates the band setting A[w] of the workload w on the current node 10 as in the following equation (1) (step S32). Note that C[w] in the following equation represents the band initial setting of the workload w on the current node 10. The band initial setting is stored in the setting information table 38. Furthermore, T[t] represents a total band of the workloads of the tenant t on the current node 10. A flowchart illustrating a flow of calculation processing for the total band of the workloads of the tenant t will be described below.

A[w]=B[t]×C[w]/T[t] (1)

That is, in the case where there is a plurality of workloads w of the tenant t on the current node 10, the allocation band B[t] of the tenant t on the current node 10 is distributed among the plurality of workloads w of the tenant t. After that, the band calculation unit 37 stores the distributed A[w] in the band setting corresponding to the appropriate workloads w in the setting information table 38.

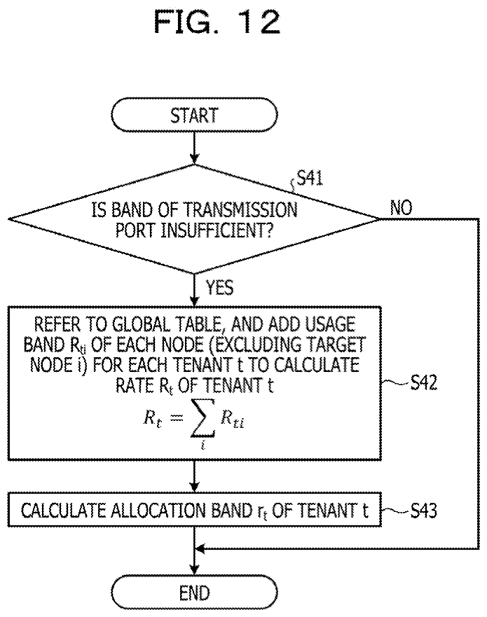

FIG. 12 is a flowchart illustrating the flow of the allocation band calculation processing. As illustrated in FIG. 12, the band calculation unit 37 determines whether the band of the transmission port (virtual port 14) is insufficient (step S41). In the case where it is determined that the band of the transmission port (virtual port 14) is not insufficient (step S41; No), the band calculation unit 37 terminates the allocation band calculation processing.

On the other hand, in the case where it is determined that the band of the transmission port (virtual port 14) is insufficient (step S41; Yes), the band calculation unit 37 refers to the global table 35 and adds the usage band Rₜᵢ of each node (excluding the current node i) for each tenant t to calculate the rate Rt of the tenant t as in the following equation (2) (step S42).

Rt=ΣᵢRₜᵢ (2)

Then, the band calculation unit 37 calculates the allocation band rₜ of the tenant t on the current node 10 (step S43).

For example, in the case where the number of tenants is 2, the equation of the allocation band r₁ of the tenant T₁ on the current node 10 can be expressed by the following equation (3). Note that L₁ represents the proportion of the band allocation of the tenant T₁ with respect to the other tenant T₂. L₂ represents the proportion of the band allocation of the tenant T₂ with respect to the other tenant T₁. C represents the band of the virtual port 14 on the current node 10. R₁ represents the rate of the tenant T₁ calculated by the equation (2). R₂ represents the rate of the tenant T₂ calculated by the equation (2).

r₁=L₁C/(L₁+L₂)−L₂R₁/(L₁+L₂)−L₁R₂/(L₁+L₂) (3)

Furthermore, in the case where the number of tenants is 2, the equation of the allocation band r₂ of the tenant T₂ on the current node 10 can be expressed by the following equation (4).

r₂=L₂C/(L₁+L₂)−L₂R₁/(L₁+L₂)−L₁R₂/(L₁+L₂) (4)

Then, the band calculation unit 37 terminates the allocation band calculation processing.

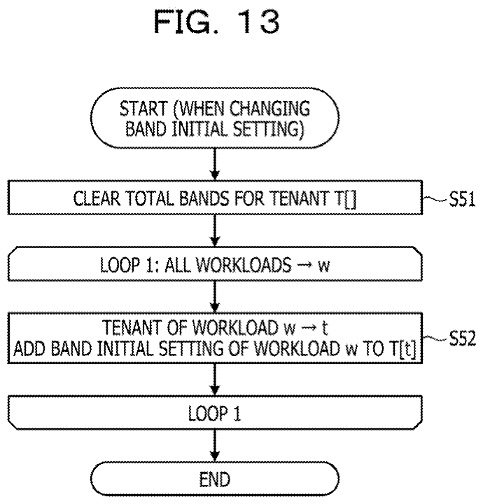

FIG. 13 is a flowchart illustrating a flow of band initial setting processing. Note that the band initial setting processing is executed when the band initial setting in the setting information table 38 is changed. As illustrated in FIG. 13, the band calculation unit 37 clears the total band area T[] for each tenant on the current node 10 (step S51).

Then, the band calculation unit 37 adds, for all the workloads w, the band initial setting of the workloads w to T[t] for each tenant t, where the workload 11 is w (step S52). The band initial setting is stored in the setting information table 38. Then, the band calculation unit 37 terminates the band initial setting processing.

In this way, since the band calculation unit 37 calculates the band to be distributed to the workload to be processed by the node 10 on the basis of the proportion of the band to be distributed to each tenant, the agent 13 becomes able to perform fair band allocation in the entire information processing system 1.

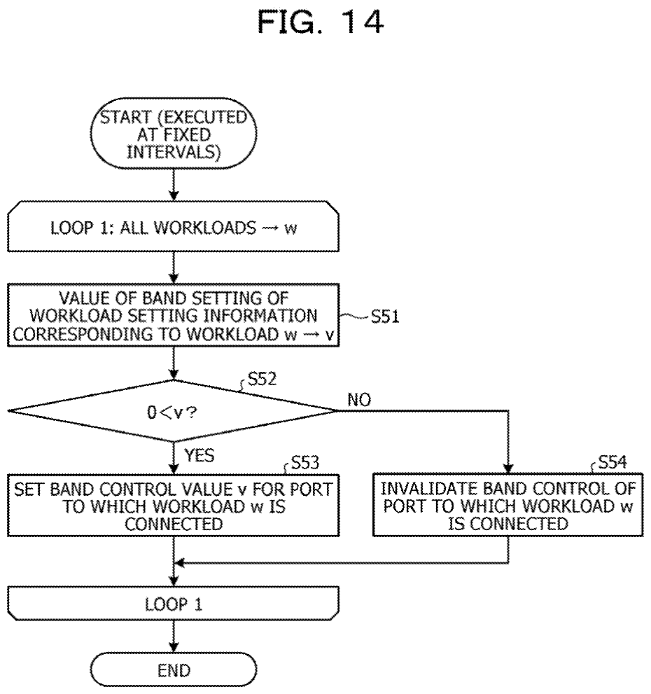

FIG. 14 is a flowchart illustrating a flow of port information setting processing. Note that the port information setting processing is executed at predetermined time intervals.

As illustrated in FIG. 14, the port information setting unit 39 executes following steps S51 to S54 for all the workloads w, where the workload 11 is w. That is, the port information setting unit 39 refers to the setting information table 38 and extracts a value v of the band setting corresponding to the workload w (step S51). Then, the port information setting unit 39 determines whether the value v is larger than 0 (step S52). In the case where it is determined that the value v is larger than 0 (step S52; Yes), the port information setting unit 39 sets the band control value v to the port to which the workload w is connected (step S53). On the other hand, in the case where it is determined that the value v is not larger than 0 (step S52; No), the port information setting unit 39 invalidates the band control of the port to which the workload w is connected (step S54).

Then, the port information setting unit 39 terminates the port information setting processing.

In this way, since the port information setting unit 39 sets, for the workload w, the band calculated by the band calculation unit 37 to the port to which the workload w is connected, the agent 13 becomes able to perform communication in a fair band in the entire information processing system 1.

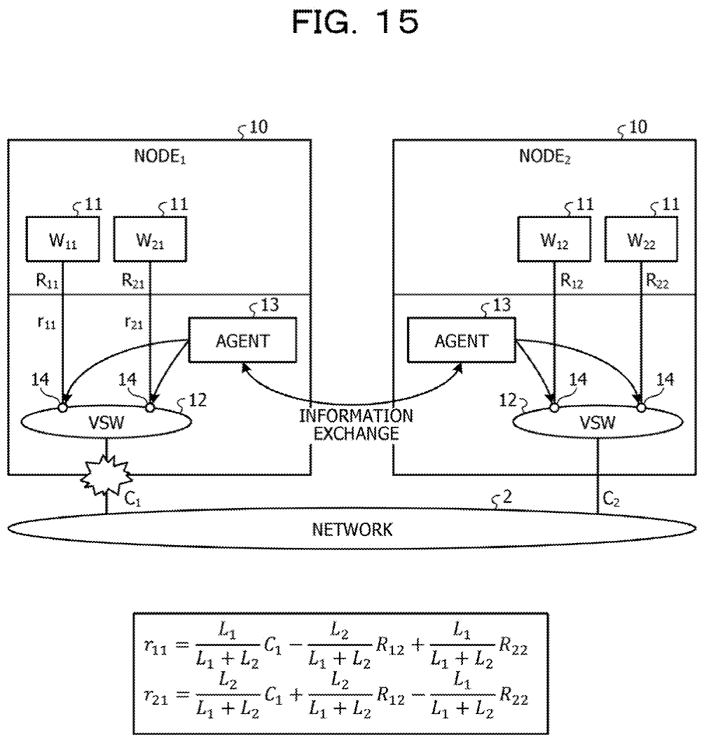

FIG. 15 is a diagram illustrating an example of band calculation. In FIG. 15, the information processing system 1 has the node₁ and the node₂. Furthermore, Wₜᵢ is the workload on the node i of the tenant t, Rₜᵢ is the rate of traffic generated by Wₜᵢ, and Cⱼ is the bandwidth of the switch port j. Note that it is assumed that there are two tenants, and the band at the proportions of L₁ and L₂ is allocated to the two tenants identified by the tenant T₁ and the tenant T₂.

Here, it is assumed that the band of the traffic generated by the workload W₁₁ is R₁₁. It is assumed that the band of the traffic generated by the workload W₂₁ is R₂₁. Then, it is assumed that the band of C₁ on the node₁ side is insufficient. Then, the band calculation unit 37 calculates the allocation band r₁₁ of the workload W₁₁ using the equation (3). The equation (3) is obtained as follows.

First, since the band at the proportions of L₁ and L₂ is allocated to the two tenants, (r₁₁+R₁₂):(r₂₁+R₂₂) has the relationship of L₁:L₂. Therefore, r₂₁ is given by the following equation (5).

r₂₁=L₂(r₁₁+R₁₂)/L₁−R₂₂ (5)

Then, since C₁ is (r₁₁+r₂₁), C₁ can be converted using the equation (5) as in the equation (6) below.

C₁=r₁₁+L₂(r₁₁+R₁₂)/L₁−R₂₂ (6)

Moreover, C₁ can be converted as in the following equations (7) and (8).

C₁=(1+L₂/L₁)r₁₁+R₁₂L₂/L₁−R₂₂ (7)

(1+L₂/L₁)r₁₁=C₁−R₁₂L₂/L₁+R₂₂ (8)

Then, r₁₁ is given by the following equation (9).

r₁₁=L₁C₁/(L₁+L₂)−L₂R₁₂/(L₁+L₂)+L₁R₂₂/(L₁+L₂) (9)

That is, r₁₁ has the same equation as the equation (3).

Similarly, r₂₁ is given by the following equation (10).

r₂₁=L₂C₁/(L₁+L₂)+L₂R₁₂/(L₁+L₂)−L₁R₂₂/(L₁+L₂) (10)

That is, r₂₁ has the same equation as the equation (4).

Note that, in this example, there is one workload for the tenant for the node₁. However, there may be a plurality of workloads for the tenant on the node₁. In such a case, the band calculation unit 37 may allocate the band for each tenant and then distribute the allocated band among a plurality of workloads as illustrated in the equation (9), (see loop 2 in FIG. 11).

Here, for the band calculation illustrated in FIG. 15, a specific numerical value is input to show the effect. For example, it is assumed that the proportions L₁ and L₂ of the band allocated to the two tenants are “1”. It is assumed that the respective bandwidths C₁ and C₂ of the virtual port 14 on the node₁ and the virtual port 14 on the node₂ are “10”. it is assumed that the traffic rate R₁₁ of the workload W₁₁ of the tenant T₁ on the node₁ is “10”. It is assumed that the traffic rate R₂₁ of the workload W₂₁ of the tenant T₂ on the node₁ is “10”. It is assumed that the traffic rate R₁₂ of the workload W₁₂ of the tenant T₁ on the node₂ is “4”. It is assumed that the traffic rate R₂₂ of the workload W₂₂ of the tenant T₂ on the node₂ is “2”.

Under these circumstances, r₁₁ is calculated on the basis of the equation (9). That is, r₁₁ is calculated as “4”. Furthermore, r₂₁ is calculated on the basis of the equation (10). That is, r₂₁ is calculated as “6”. Then, the band R₁ allocated to the tenant T₁ is a value of the sum of r₁₁ and R₁₂, so the value becomes “8” (=4+4). Furthermore, the band R₂ allocated to the tenant T₂ is a value of the sum of r₂₁ and R₂₂, so the value becomes “8” (=6+2). That is, the band calculation processing can calculate the band so as to be fair among tenants.

Note that, in the case of calculating the band using only the information of the node₁, r₁₁ and r₂₁ are calculated on the basis of the following equations, respectively.

r₁₁=L₁C₁/(L₁+L₂)

r₂₁=L₂C₁/(L₁+L₂)

That is, r₁₁ and r₂₁ are calculated as “5”. Then, the band R₁ allocated to the tenant T₁ is a value of the sum of r₁₁ and R₁₂, so the value becomes “9” (=5+4). Furthermore, the band R₂ allocated to the tenant T₂ is a value of the sum of r₂₁ and R₂₂, so the value becomes “7” (=5+2). In other words, in the processing of calculating the band only with the information of the node₁, the band is unfairly calculated between tenants.

### Effect of First Embodiment

In this way, in the above-described first embodiment, each node 10 provided with a plurality of workloads for each of a plurality of tenants performs the following processing. The node 10 acquires the use band information for each tenant in another node 10. The node 10 calculates the band to be distributed to the workload 11 to be processed by the information processing device on the basis of the acquired use band information. The node 10 sets the calculated band. According to such a configuration, the information processing system 1 can control the band so as to be fair among tenants in the entire information processing system 1.

Furthermore, in the above-described first embodiment, the node 10 acquires the use band information for each tenant in the another node 10 by exchanging the use band information for each tenant with the another node 10. According to such a configuration, the node 10 can control the band so as to be fair among tenants in the entire information processing system 1 by acquiring the use band information for each tenant of another node 10.

Furthermore, in the above-described first embodiment, the node 10 calculates the band to be distributed to the workload to be processed by the information processing device on the basis of the proportion of the band to be distributed to each tenant in the information processing system 1. According to such a configuration, the node 10 can perform fair band allocation among tenants in the entire information processing system 1.

Furthermore, in the above-described first embodiment, the node 10 determines the workload 11 for which the band is to be set, and sets the calculated band for the determined workload 11. According to such a configuration, the node 10 can perform communication in a fair band in the entire information processing system 1.

### Second Embodiment

By the way, in the first embodiment, the description has been made such that the node 10 calculates the band to be distributed to the workload 11 to be processed by the information processing device on the basis of the use band information for each tenant in another node 10 and sets the calculated band. However, due to hardware resource restrictions, the number of ports for which the band can be set may be limited.

Therefore, in a second embodiment, a case in which a node 10 determines a virtual port 14 for which a band can be set, and sets a calculated band for the determined virtual port 14 will be described.

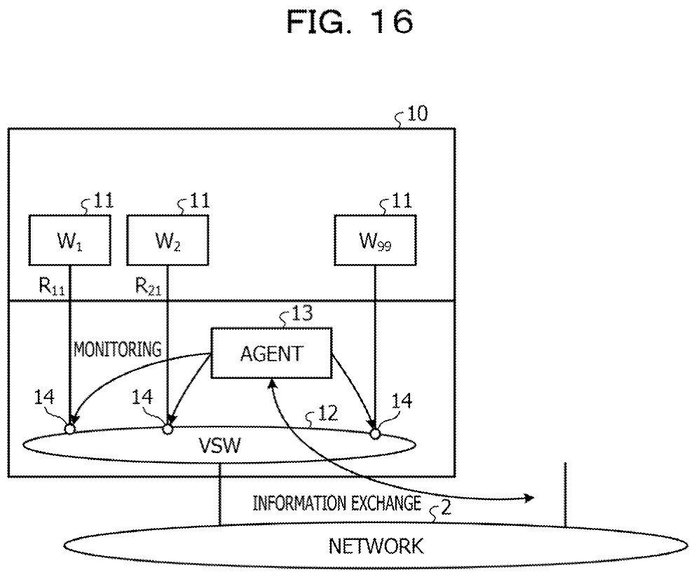

Here, band control by an information processing system 1 will be described with reference to FIG. 16. FIG. 16 is a diagram for describing band control by the information processing system according to the second embodiment. As illustrated in FIG. 16, in a container environment, more than 100 containers (workloads 11) are executed on one node 10. However, due to hardware resource constraints, the number of virtual ports 14 for which a band can be set is limited. Therefore, the node 10 determines the virtual port 14 for which the band can be set, and sets the calculated band for the determined virtual port 14.

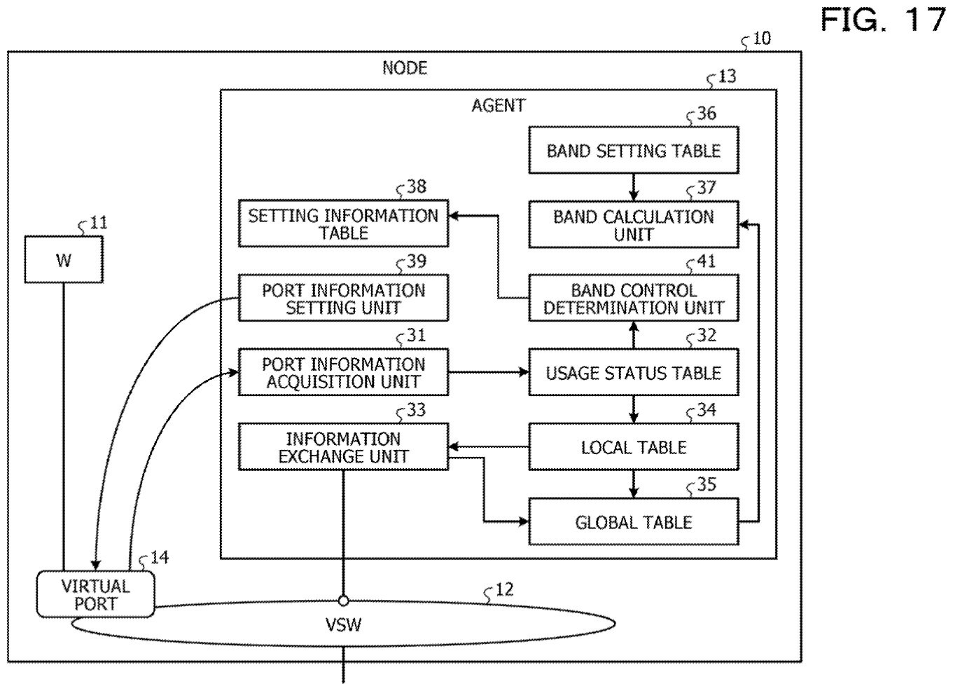

FIG. 17 is a diagram illustrating a functional configuration of an agent according to the second embodiment. Note that the same configuration as that of the agent 13 illustrated in FIG. 3 is given the same reference numeral, and description regarding the overlapping configuration and operation is omitted. The difference of the second embodiment from the first embodiment is that a band control determination unit 41 is added. Note that the band control determination unit 41 is an example of a determination unit.

The band control determination unit 41 determines the workload 11 for band control. For example, the band control determination unit 41 determines whether to control the band of the workload 11 for all the workloads 11 of the node 10. As an example, the band control determination unit 41 generates a list of values each obtained by subtracting a value of a set band (allocation band) from a value of a usage band for each workload 11. Then, the band control determination unit 41 determines top n workloads 11 in the generated list as the target workloads 11 for band control, where n is a band-controllable number. Then, the band control determination unit 41 sets the value of the band setting of the workload 11, which is in band setting of a setting information table 38 but is not the target for band control, to “0”. That is, the band control determination unit 41 invalidates the band setting of the workload 11 that is not the target for band control.

A band calculation unit 37 calculates the band to be distributed to the workload 11 for the target workload 11 for band control determined by the band control determination unit 41. For example, in the diagram of band calculation illustrated in FIG. 15, it is assumed that a node₁ has a workload W₁₃ for a tenants. Then, it is assumed that, in the case where the band-controllable number n is 2, the workload W₁₃ is not determined as the target workload 11 for band control, and workloads W₁₁ and W₂₁ are determined as the target workloads 11 for band control. Then, the band calculation unit 37 calculates the band of the workload belonging to the tenant₁ as r₁₁, using the equation (9). The band calculation unit 37 calculates the band of the workload belonging to a tenant₂ as r₂₁, using the equation (10). Then, the band calculation unit 37 may set the value of the band setting of the workload W₁₁ to be the value obtained by subtracting the value “0” of the band setting of the workload W₁₃ from r₁₁. Note that the band calculation unit 37 does not calculate the band because the band setting of the workload W₁₃ is invalidated.

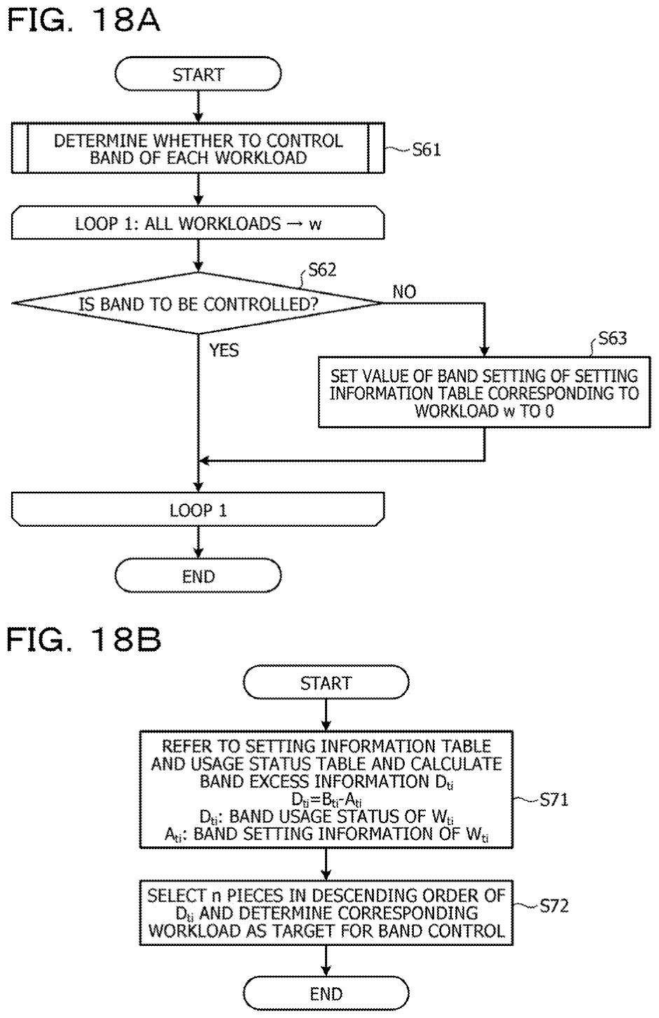

FIGS. 18A and 18B are flowcharts illustrating a flow of band control determination processing. Note that the band control determination processing is executed at predetermined time intervals.

As illustrated in FIG. 18A, the band control determination unit 41 determines whether to control the band of each workload 11 for the node 10 (step S61). Note that a flowchart illustrating a flow of processing for determining whether to control the band of each workload 11 will be described below.

Then, the band control determination unit 41 executes following steps S62 and S63 for all the workloads w, where the workload 11 is w. That is, the band control determination unit 41 determines whether to perform band control for the workload w (step S62). When it is determined not to perform band control (step S62; No), the band control determination unit 41 sets the value of the band setting of the setting information table 38 corresponding to the workload w to “0” (step S63). On the other hand, when it is determined to perform band control (step S62; Yes), the band control determination unit 41 terminates the band control determination processing in order to perform band calculation thereafter.

As illustrated in FIG. 18B, the band control determination unit 41 refers to the setting information table 38 and a usage status table 32, and calculates band excess information Dₜᵢ(=Bₜᵢ−Aₜᵢ) of the node 11(i) (step S71). Here, Bₜᵢ represents the band usage status of the workload Wₜᵢ on the node i (the usage band in the usage status table 32). Aₜᵢ represents the band setting information of the workload Wₜᵢ on the node i (the band setting in the setting information table 38).

Then, the band control determination unit 41 selects n pieces in descending order of Dₜᵢ, and determines the corresponding workload Wₜᵢ as the target workload for band control (step S72).

### Effect of Second Embodiment

In this way, in the above-described second embodiment, in the case where the number of workloads 11 to be processed by the node 10 exceeds the settable number of bands, the node 10 performs the following processing. The node 10 determines, for the virtual port 14 to be used for the workload 11, the workload 11 corresponding to the virtual port 14 as the target for band control according to the difference obtained by subtracting the setting information of the band from the use information of the band. Then, the node 10 calculates the band to be distributed to the workload 11 determined as the target for band control. According to such a configuration, even in the case where there is a limit on the number of ports to which the band can be set due to restrictions on hardware resources, the node 10 can control the band to be distributed to the workload 11 to be processed by the node 10 so as to be fair among tenants.

### Third Embodiment

By the way, in the first embodiment, the description has been given such that the node 10 acquires the use band information for each tenant in another node 10 by exchanging the use band information for each tenant with the another node 10. However, the embodiment is not limited thereto, and the node 10 may acquire the use band information for each tenant on another node 10 by exchanging the use band information for each tenant with another node 10 via a commonly accessible storage area by a plurality of nodes 10.

Therefore, in a third embodiment, a case in which a node 10 acquires use band information for each tenant on another node 10 by exchanging the use band information for each tenant with the another node 10 via a commonly accessible storage area by a plurality of nodes 10 will be described.

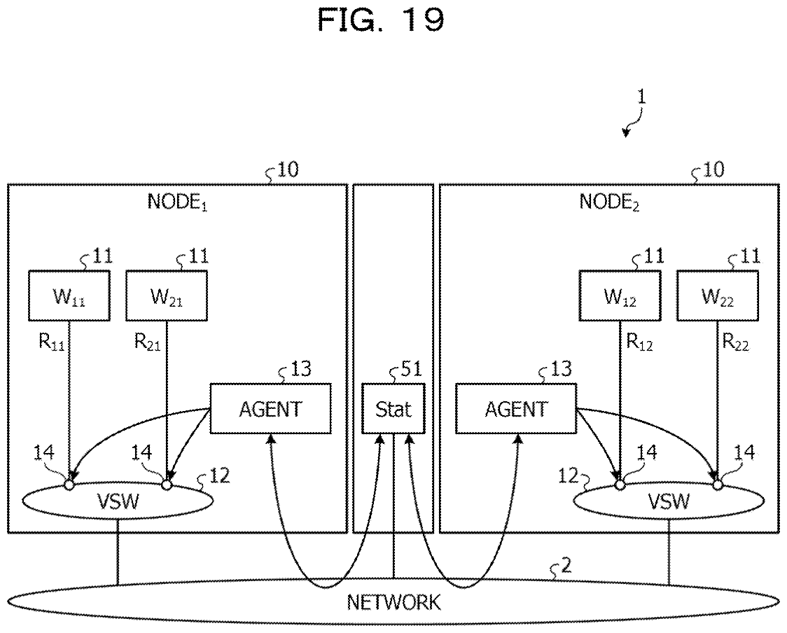

Here, a configuration of an information processing system 1 according to the third embodiment will be described with reference to FIG. 19. FIG. 19 is a diagram illustrating an example of a configuration of the information processing system according to the third embodiment. As illustrated in FIG. 19, the information processing system 1 has a Stat 51 in addition to a plurality of nodes 10. The Stat 51 is a commonly accessible storage area by a plurality of nodes 10. An agent 13 of each node 10 writes the use band information for each tenant to the Stat 51 as the commonly accessible storage area by the plurality of nodes 10. Then, the agent 13 reads the use band information for each tenant of another node 10 from the Stat 51.

For example, an information exchange unit 33 of the agent 13 creates a local table 34 on the basis of information stored in a usage status table 32 of the node 10. Then, the information exchange unit 33 exchanges the content of the local table 34 with the agent 13 of the another node 10 via the Stat 51. Then, the information exchange unit 33 creates a global table 35 on the basis of the band use status of the another node 10 and information stored in the local table 34.

### Effects of Third Embodiment

In this way, in the above-described third embodiment, the node 10 acquires the use band information for each tenant on another node 10 by exchanging the use band information for each tenant with the another node 10 via the commonly accessible storage area by the plurality of nodes 10. According to such a configuration, the node 10 can acquire the use band information for each tenant of another node 10 as needed by using the commonly accessible storage area by the plurality of nodes 10.

### Fourth Embodiment

By the way, in the first embodiment, the agent 13 of each node 10 creates the local table 34 on the basis of the information stored in the usage status table 32, and exchanges the content of the local table 34 with the agent 13 of another node 10 and creates the global table 35. Then, the agent 13 calculates the allocation band of each virtual port 14 of the node 10 by using the global table 35 such that the bands allocated to the tenants become the set proportions in the entire information processing system 1, and distributes the band to the workload 11 of each tenant. Furthermore, in the third embodiment, each node 10 exchanges the use band information for each tenant with another node 10 via the commonly accessible storage area by the plurality of nodes 10. However, the information processing system 1 is not limited thereto, and may include a controller for processing the storage area in addition to the commonly accessible storage area by the plurality of nodes 10.

Therefore, in a fourth embodiment, a case in which an information processing system 1 includes, in addition to a commonly accessible storage area by a plurality of nodes 10, a controller that processes the storage area will be described.

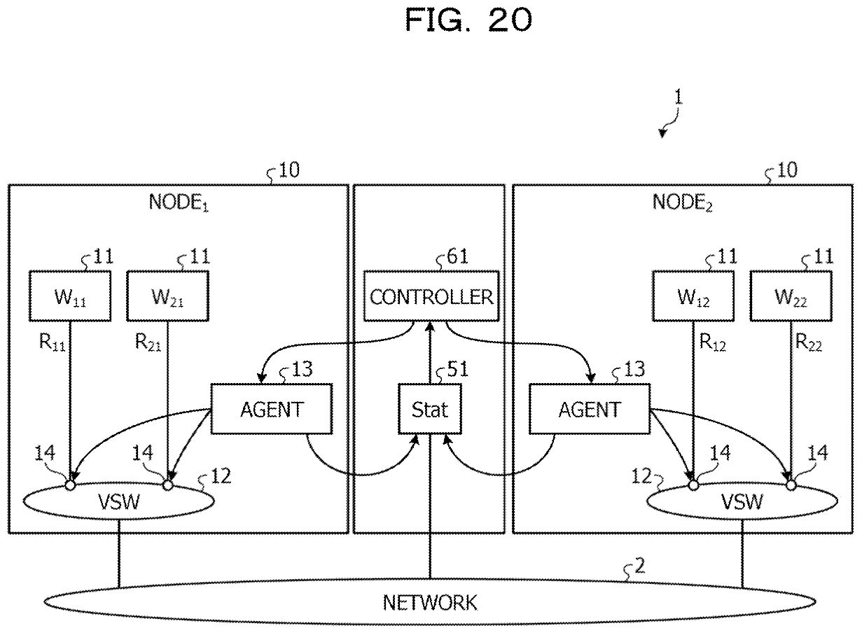

Here, a configuration of the information processing system 1 according to the fourth embodiment will be described with reference to FIG. 20. FIG. 20 is a diagram illustrating an example of a configuration of the information processing system according to the fourth embodiment. As illustrated in FIG. 20, the information processing system 1 has a Stat 51 and a controller 61 in addition to a plurality of nodes 10. The Stat 51 is a commonly accessible storage area by the plurality of nodes 10. The controller 61 manages the Stat 51, calculates band distribution of each node 10, and issues an instruction to an agent 13 of each node 10.

For example, in each node 10, an information exchange unit 33 of the agent 13 creates a local table 34 on the basis of information stored in a usage status table 32 of the node 10, and writes the local table 34 of the node 10 to the Stat 51. Then, the controller 61 creates a global table 35 from the local table 34 of each node 10. Then, the controller 61 calculates the band to be allocated to the tenant for each node 10, using the global table 35, such that bands allocated to tenants in the entire information processing system 1 become set proportions. Then, the controller 61 notifies each node of the calculated band to be allocated to the tenant. Then, in each node 10, a band calculation unit 37 of the agent 13 distributes the band to a workload 11 of each tenant, using the notified band to be allocated to the tenant.

### Effects of Fourth Embodiment

In this way, in the above-described fourth embodiment, the controller 61 acquires the use band information for each tenant on each node 10 from the Stat 51, and calculates the band for each tenant on each node 10 on the basis of the acquired use band information. Then, the controller 61 notifies each node 10 of the calculated band for each tenant on the each node 10. Furthermore, each node 10 writes the use band information for each tenant on the node 10 to the Stat 51. Then, each node 10 calculates the band to be distributed to the workload 11 to be processed by the node 10 on the basis of the notified band for each tenant on the node 10. Then, each node 10 sets the calculated band to a virtual port 14. According to such a configuration, since the controller 61 calculates the band for each tenant on each node 10, each node 10 can reduce the load on the band calculation processing. Furthermore, since the controller 61 collectively calculates the band for each tenant on each node 10, it is possible to reliably control the band so as to be fair among tenants in the entire information processing system 1.

Note that each node 10 can be implemented by mounting the functions of the above-described agent 13 and the like on an information processing device such as an existing personal computer or workstation.

Furthermore, in the first to fourth embodiments, the case in which the workload 11 is, for example, a container in a container environment has been described, but the present embodiment is not limited to the case and is also applicable to, for example, an application belonging to a tenant.

Furthermore, each of the components of the node 10 illustrated in the drawings does not necessarily need to be physically configured as illustrated in the drawings. For example, specific aspects of separation and integration of the node 10 are not limited to the illustrated ones, and all or a part of the apparatus can be functionally or physically separated and integrated in an arbitrary unit according to various loads, use states, or the like. For example, the band calculation unit 37 may be distributed into a first band calculation unit that calculates the band for each tenant and a second band calculation unit that calculates the band to be allocated to the workload 11 of each tenant from the band for each tenant. Furthermore, the port information acquisition unit 31 and the port information setting unit 39 may be integrated. Furthermore, a storage unit (not illustrated) that stores various tables may be connected via a network as an external device of the node 10.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing device comprising:
a memory; and
a processor coupled to the memory and configured to:
acquire use band information for each of a plurality of tenants each including a plurality of workloads in another information processing device;
calculate a band to be distributed to the workload to be processed by the information processing device on the basis of the use band information; and
set the band which is calculated.

2. The information processing device according to claim 1, wherein
the processor acquires the use band information for each tenant in the another information processing device by exchanging the use band information for each tenant with the another information processing device.

3. The information processing device according to claim 1, wherein
the processor acquires the use band information for each tenant in the another information processing device by exchanging the use band information for each tenant with the another information processing device via a commonly accessible storage area by the plurality of information processing devices.

4. The information processing device according to claim 1, wherein
the processor calculates the band to be distributed to the workload to be processed by the information processing device on the basis of a proportion of a band to be distributed to each tenant in the information processing device.

5. The information processing device according to claim 1, wherein,
the processor determines a workload to which a band is to be set and sets the band for the workload which is determined.

6. The information processing device according to claim 5, wherein,
in a case where the number of workloads to be processed by the information processing device exceeds a settable number of bands, the processor determines, for a port to be used in a workload, the workload that corresponds to the port as a target for band control according to a difference obtained by subtracting band setting information from band use information.

7. An information processing system that processes a plurality of workloads for each of a plurality of tenants, using a plurality of information processing devices,
each of the information processing devices comprising:
a memory; and
a processor coupled to the memory and configured to:
acquire use band information for each tenant in another information processing device;
calculate a band to be distributed to the workload to be processed by each of the information processing devices on the basis of the use band information; and
set the band which is calculated.

8. A band control method comprising:
acquiring, by an information processing device, use band information for each of a plurality of tenants each including a plurality of workloads in another information processing device;
calculating a band to be distributed to the workload to be processed by the information processing device on the basis of the use band information; and
setting the band which is calculated.
